(19) United States
(12) Patent Application Publication
(10) Pub. No.: US 2007/0144749 A1
(43) Pub. Date: Jun. 28, 2007

(54) PERCUSSION BOLT FOR A PERCUSSION MECHANISM

(76) Inventors: Ludwig Thome, Leinfelde-Echterdingen (DE); Thilo Henke, Stuttgart (DE)

Correspondence Address: MICHAEL J. STRIKER, 103 EAST NECK ROAD, HUNTINGTON, NY, 11743, US

(21) Appl. No.: 11/610,311

(22) Filed: Dec. 13, 2006

(30) Foreign Application Priority Data
Dec. 28, 2005 (DE) 10 2005 062 777.3

(51) Int. Cl. B23B 45/16

(52) U.S. Cl. 173/128

(57) ABSTRACT

A percussion bolt for a percussion mechanism of a power tool has a bolt element having a contact shoulder, said contact shoulder as seen in circumferential direction having a cross-section which varies.

### CROSS-REFERENCE TO A RELATED APPLICATION

The invention described and claimed hereinbelow is also described in German Patent Application DE 102005062777. filed on Dec. 28, 2005. This German Patent Application, whose subject matter is incorporated here by reference, provides the basis for a claim of priority of invention under 35 U.S.C. 119(a)-(d).

### BACKGROUND OF THE INVENTION

The present invention generally relates to a percussion bolt for a power tool percussion mechanism. More particularly, it relates to a percussion bolt for a percussion mechanism of a power tool, in particular of a hand power tool, in which the percussion bolt has a contact shoulder.

A percussion bolt of this kind for a percussion mechanism is known. The percussion bolt, also known as a snap head die, is an intermediate element which is located between the percussion mechanism and a tool receptacle, or a tool of the power tool. A beater, moved back and forth in the percussion mechanism, transmits a pulse upon impact against the percussion bolt. The percussion bolt absorbs the pulse and converts it into a tension wave, which it transmits to the tool. A user of the power tool—for instance in the case of a hand power tool—presses against a contact shoulder of the percussion bolt via an element that is connected to the housing, so that he can press the tool, located upstream of the percussion bolt, against a workpiece and moves the percussion mechanism from a position of repose into a working position. The contact shoulder is embodied such that in a shoulder region, it forms a cross-sectional thickening on the percussion bolt. In particular, it can be embodied as an annular shoulder, which makes a contact face available over the full circumference.

In such a percussion bolt with a contact shoulder, breakage of the percussion bolt often occurs. One cause of such a break is an overload, which occurs preferentially in regions in which an abrupt change in the cross-sectional area (or cross-sectional discontinuity) occurs in the longitudinal direction of the percussion bolt. This kind of change in the cross-sectional area occurs especially in a boundary region between the shoulder region and adjacent regions of the percussion bolt. When the beater strikes the percussion bolt, a tension wave is created, which is partly reflected in regions that have cross-sectional discontinuities, so that superposition of the tension waves occurs inside the percussion bolt. In the event of a structural superposition, an overload on the material and breakage of the percussion bolt can occur in the corresponding region of the percussion bolt.

### SUMMARY OF THE INVENTION

Accordingly, it is an object of the present invention to provide a percussion bolt for a percussion mechanism of a power tool, which eliminates the disadvantages of the prior art.

The percussion bolt of the invention has a contact shoulder, whose cross section—viewed in the circumferential direction of the percussion bolt—varies, and/or there is at least one contact-shoulder-free circumferential portion. This offers the advantage that the resultant cross-sectional discontinuity in the shoulder region is markedly reduced, and a contact face required for pressing the tool against the workpiece is preserved. In corresponding circumferential portions of the contact shoulder, the cross-sectional discontinuity is unchanged, while at least one circumferential portion has a lesser cross-sectional discontinuity, or—in the case of a shoulder-free circumferential portion—none at all, compared to adjoining regions of the percussion bolt, so that the overall cross-sectional discontinuity is less.

Preferably, the percussion bolt, over its length—with the exception of a shoulder region that has the contact shoulder—has a cross section that remains constant or virtually constant. If the cross section remains the same, the tension waves until striking the end of the percussion bolt toward the tool are reflected to only a lesser extent if at all, so that superposition of the tension waves is reduced to a minimum. If there are only small cross-sectional changes, and in particular if no cross-sectional discontinuities occur, then partial reflections of only slight magnitude occur, which in superposition on an original wave cause only a slight exaggeration of the resultant tension wave. The same is true for a moderate but steady change in the cross section of the percussion bolt over its length.

In a further feature of the invention, it is provided that the percussion bolt and the contact shoulder, in the shoulder region, have a total cross section which is equal or approximately equal to the cross section of the percussion bolt in adjacent regions. In this kind of design of the percussion bolt and contact shoulder, there is no cross-sectional discontinuity, or a cross-sectional discontinuity of only slight magnitude occurs, so that tension waves in these boundary regions are hardly reflected, if at all.

In particular, it is provided that the contact shoulder is formed by one or more circumferentially located contact shoulder elements. The contact shoulder elements are designed and located such that they are capable of transmitting the pressure, exerted by the user via the percussion bolt, to the tool.

In a further feature of the invention, it is provided that the percussion bolt, in at least one contact-shoulder-free circumferential portion, has an indentation. By means of an indentation in the percussion bolt in a shoulder-free circumferential portion, the increase in the total cross section in other portions of the contact shoulder can be compensated for, so that the total cross section of the percussion bolt and of the contact shoulder in the shoulder region can be of the same magnitude as the cross section of the percussion bolt in adjacent regions.

It can furthermore be advantageous if the contact shoulder elements are symmetrically located, so that by pressure on the contact shoulder elements, a total pressure oriented along the longitudinal axis of the percussion bolt is exerted on the tool.

In a further feature of the invention, it is provided that the contact shoulder elements are embodied identically, so that for the same pressure, equal forces are also exerted onto the contact shoulder elements.

In a further feature of the invention, it is provided that the contact-shoulder-free circumferential portions are embodied identically. Since the percussion bolt has a smaller total cross section in the region of these circumferential portions, especially if one or more shoulder-free circumferential portions have indentations, increased stresses occur at these points, and these stresses are distributed as uniformly as possible.

The invention further relates to a power tool, in particular a hand power tool, having a percussion bolt as defined by at least one of the characteristics named above. This power tool may be embodied as a hand power tool, in particular as a drill hammer or percussion hammer.

The novel features of which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a side view of a percussion bolt with a contact shoulder, in a first exemplary embodiment;

FIG. 2 is a sectional view through the percussion bolt shown in FIG. 1, in a shoulder region; and

FIG. 3 is a sectional view through a percussion bolt in the shoulder region, in a second exemplary embodiment.

### DESCRIPTION OF THE PREFERRED EMBODIMENTS

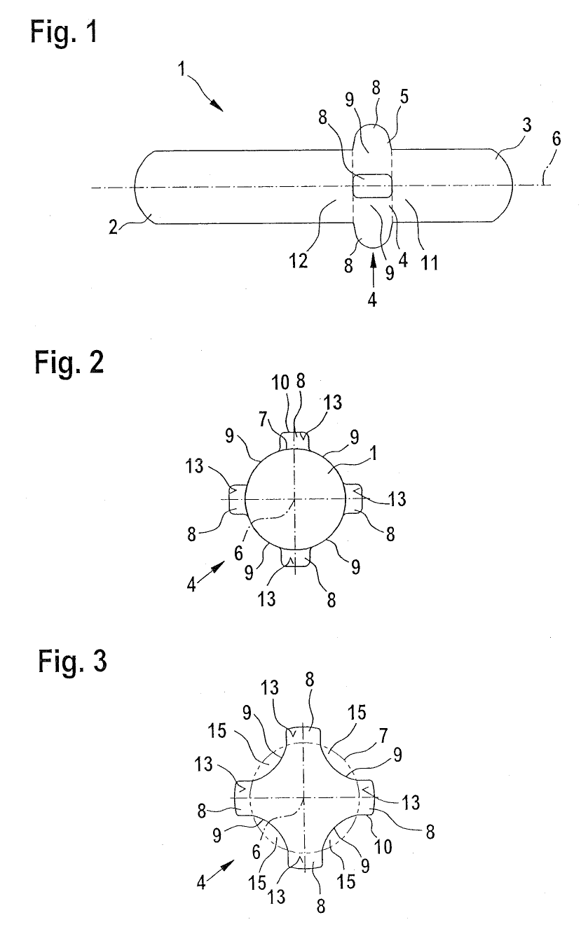

In FIG. 1, a percussion bolt 1 is shown of a power tool, not shown. The percussion bolt 1 has an end region 2, facing toward a tool holder or tool that is not shown, and also has an end region 3 oriented toward a percussion mechanism, not shown. In a shoulder region 4 located between these end regions, the percussion bolt 1 has a contact shoulder 5, which surrounds the percussion bolt 1 on the circumference—in at least some portions.

Outside the shoulder region 4, the percussion bolt 1 is embodied cylindrically between the end regions 2, 3; that is, it has a constant circular cross section 7 along the longitudinal axis 6. The contact shoulder 5, in the shoulder region 4, has a plurality of shoulder elements 8, which point essentially radially outward. Between the contact shoulder elements 8, there are shoulder-free circumferential portions 9 of the contact shoulder 5. The contact shoulder 5 has a total cross section 10 which is greater along the entire shoulder region 4 than the cross section 7 of the percussion bolt 1 in the regions 11, 12 of the percussion bolt 1 that are adjacent to the shoulder region 4.

FIG. 2 shows the percussion bolt 1 and the contact shoulder 5 in a sectional view in the shoulder region 4 transversely to the longitudinal axis. Four identically embodied contact shoulder elements 8 are located symmetrically around the circular cross section 7 of the percussion bolt 1 and each have a contoured face 13 in the cross section. Between the contact shoulder elements 8, there are four identically embodied shoulder-free circumferential portions 9. The total cross section 10 is greater, by the sum of the contoured faces 13, than the cross section 7 of the percussion bolt 1 in the adjacent regions 11, 12 of the shoulder region 4.

The following function of the percussion bolt 1 of the power tool is the result: A beater, not shown, is moved back and forth in the percussion mechanism and in the process periodically strikes the end region 3 of the percussion bolt 1 and in the process transmits a pulse to the percussion bolt 1. The percussion bolt absorbs the pulse and an attendant impact energy and converts them into a tension wave.

The tension wave travels through the percussion bolt 1 essentially parallel to the longitudinal axis 6 and then at the diametrically opposed end region 2 is transmitted onward by a further pulse transmission to the tool, not shown—or to the tool holder, not shown. The tension wave, not shown, on traveling through the percussion bolt is partly reflected preferentially at regions that have major sudden changes in cross section of the percussion bolt 1. The original tension wave and reflected tension waves are superimposed on one another inside the percussion bolt 1, causing local exaggeration of the tension that can cause breakage of the percussion bolt. In order to avoid this kind of tension exaggeration in the percussion mode, the cross section 7 of the percussion bolt 1 remains largely constant.

To be able to press the tool against a workpiece via the percussion bolt 1, the percussion bolt 1 requires a contact shoulder 5, which cooperates with a housing part of the power tool and onto which the user can exert pressure. If the contact shoulder 5 is embodied as a circumferential cross-sectional thickening 14, then in the shoulder region 4 a change occurs in the total cross section of the percussion bolt 1 and contact shoulder 5. To keep this change in cross section as slight as possible, the contact shoulder 5 is designed as contact shoulder elements 8 that are separated from one another by shoulder-free circumferential portions 9; in the region of the shoulder-free circumferential portions 9, no change in the cross section of the percussion bolt 1 occurs. However, a change in cross section does remain in the region of the contact shoulder elements 8.

To further reduce the change in cross section, the total cross section 10 in the shoulder region 4 can be produced by means of at least one indentation 15 in one of the shoulder-free circumferential portions 9, in such a way that the cross-sectional area of the total cross section 10 in the shoulder region 4 is equivalent or approximately equivalent to the cross-sectional area of the cross section 7 in the adjacent regions 11, 12.

FIG. 3 shows a percussion bolt 1 of this kind with indentations 15 in the shoulder-free circumferential portions 9, in a sectional view crosswise to the longitudinal axis. FIG. 3 is essentially equivalent to FIG. 2, with the exception of the symmetrically and identically embodied indentations 15 between the contact shoulder elements 8.

In addition to a version of the percussion bolt 1 with four symmetrically located contact shoulder elements 8, the percussion bolt 1 may have any other number of contact shoulder elements 8, in particular three contact shoulder elements 8, instead.

The indentation 15 or indentations 15 may be provided directly in the manufacture of the percussion bolt 1, or—for example by milling—they may be made afterward in a percussion bolt 1.

It will be understood that each of the elements described above, or two or more together, may also find a useful application in other types of constructions differing from the type described above.

While the invention has been illustrated and described as embodied in a percussion bolt for a percussion mechanism, it is not intended to be limited to the details shown, since various modifications and structural changes may be made without departing in any way from the spirit of the present invention.

Without further analysis, the foregoing will so fully reveal the gist of the present invention that others can, be applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. A percussion bolt for a percussion mechanism of a power tool, comprising a bolt element having a contact shoulder, said contact shoulder as seen in circumferential direction having a cross-section which varies.

2. A percussion bolt as defined in claim 1, wherein said bolt element has a first end adapted to face a second holder and a second end adapted to face the percussion mechanism, said contact shoulder being located between said ends.

3. A percussion bolt as defined in claim 1, wherein said contact shoulder has at least one shoulder-free circumferential portion.

4. A percussion bolt as defined in claim 1, wherein said bolt element over its length, with an exception of a region provided with said contact shoulder, has a cross-section that remains constant.

5. A percussion bolt as defined in claim 1, wherein said bolt element over its length, with an exception of a region provided with said contact shoulder, has a cross-section that remains substantially constant.

6. A percussion bolt as defined in claim 1, wherein said bolt and said contact shoulder in said region of said contact shoulder have a total cross-section which is equal to a cross-section of said bolt element in adjacent regions.

7. A percussion bolt as defined in claim 1, wherein said bolt and said contact shoulder in said region of said contact shoulder have a total cross-section which is substantially equal to a cross-section of said bolt element in adjacent regions.

8. A percussion bolt as defined in claim 1, wherein said contact shoulder is formed by at least one contact shoulder element as seen in a circumferential direction of said contact shoulder.

9. A percussion bolt as defined in claim 1, wherein said contact shoulder is formed by a plurality of circumferentially spaced contact shoulder elements.

10. A percussion bolt as defined in claim 3, wherein said bolt element in at least said shoulder-free circumferential portion, is provided with an indentation.

11. A percussion bolt as defined in claim 9, wherein said contact shoulder elements are located symmetrically.

12. A percussion bolt as defined in claim 10, wherein said contact shoulder elements are formed as identical elements.

13. A percussion bolt as defined in claim 1, wherein said contact shoulder has a plurality of a circumferentially spaced shoulder-free portions.

14. A percussion bolt as defined in claim 13, wherein said shoulder-free portions are formed as identical portions.

15. A power tool, comprising a percussion mechanism provided with a percussion bolt, said percussion bolt having a bolt element having a contact shoulder, said contact shoulder as seen in circumferential direction having a cross-section which varies.
